(19) United States
(12) Patent Application Publication
(10) Pub. No.: US 2025/0188331 A1
(43) Pub. Date: Jun. 12, 2025

(54) Bio-based Adhesive Composition Based on Lignin

(71) Applicant: Georg-August-Universität Göttingen Stiftung Öffentlichen Rechts, Göttingen (DE)

(72) Inventors: Sandip Singh, Uttar Pradesh (IN); Kai Zhang, Bovenden (DE)

(73) Assignee: Georg-August-Universität Göttingen Stiftung Öffentlichen Rechts, Göttingen (DE)

(21) Appl. No.: 18/837,605

(22) PCT Filed: Feb. 15, 2023
(86) PCT No.: PCT/EP2023/053816

§ 371 Date: Aug. 12, 2024

(30) Foreign Application Priority Data
Feb. 17, 2022 (DE) 10 2022 103 784.3

(51) Int. Cl. C09J 197/00; C08H 7/00; C09J 5/00

(52) U.S. Cl. CPC C09J 197/005; C08H 6/00; C09J 5/00; C09J 2497/00

(57) ABSTRACT

The present invention relates to an adhesive composition based on a lignin structure, wherein the lignin structure is a lignin functionalised by reaction with dimethylformamide and acrylic acid.

The present invention relates to a bio-based adhesive composition based on lignin. The present invention further relates to a method for producing such an adhesive composition.

Phenol-formaldehyde resins are used for a variety of applications, including bonding metals, wood, plastics, paper and rubber with reasonable cost and mechanical properties. Therefore, formaldehyde is also used in some other resins, such as urea-formaldehyde and melamine-formaldehyde resins, which are produced in large quantities and are used for wood adhesives or mineral fiber binders.

However, both phenol and formaldehyde are considered as environmentally harmful chemicals and are associated with various health problems.

Thus, there is an interest in finding alternative substances in order to replace phenol and/or formaldehyde in such applications.

In this regard, emerging biorefinery technologies are gaining interest to meet market demand by producing renewable and sustainable chemicals, materials, fuels and polymers. Lignin from the biorefinery and pulp industry is still a solid waste stream that is currently incinerated for energy production, with the exception of partial recovery of certain chemicals.

In recent decades, lignin has been used as a partial or complete replacement for phenol in phenol-formaldehyde wood adhesives. The partial replacement or substitution of formaldehyde with less toxic, less volatile or bio-based compounds may provide further positive benefits with respect to the health risks to workers and the environmental problems caused by chronic exposure to formaldehyde during the resin manufacturing process.

For example, Kalami, S.; Arefmanesh, M.; Master, E.; Nejad, M., “Replacing 100% of phenol in phenolic adhesive formulations with lignin”, Journal of Applied Polymer Science 2017, 134 (30), 45124, describes the replacement of phenol with lignin in adhesive compositions.

The solutions known from the prior art may thus still have potential for improvement, in particular with regard to providing improved adhesive compositions.

It is therefore an object of the present invention to provide a measure by which at least one disadvantage of the prior art is at least partially overcome. In particular, it is an object of the present invention to provide a solution by means of which adhesive compositions can be improved, in particular with regard to their environmental harmfulness or toxicity.

According to the invention, the object is achieved by an adhesive composition with the features of claim 1. According to the invention, the object is further achieved by a method with the features of claim 5, an adhesive composition with the features of claim 9 and a use with the features of claim 10. Preferred embodiments of the invention are disclosed in the subclaims, in the description, in the example and in the figures, wherein further features described or shown in the subclaims or in the description or the figures or in the example may individually or in any combination constitute a subject matter of the invention, unless the context clearly indicates otherwise.

The present invention relates to a bio-based adhesive composition comprising a lignin structure, wherein the lignin structure is a lignin functionalized by reaction with dimethylformamide and acrylic acid.

Such an adhesive composition allows a strong and secure adhesive bond and good weather resistance in a variety of applications. Furthermore, ecological and safety aspects can be improved compared to prior art solutions.

The present invention thus relates to a bio-based adhesive composition. In the sense of the invention, the term “bio-based” is understood to mean that the adhesive composition was not or not entirely synthetically produced, but that at least one component, preferably the main component, is a natural polymer.

In the context of the present invention, it has been shown that lignin, such as in particular untreated lignin or crude lignin, is particularly suitable as a starting point.

In this respect, it should be mentioned that lignin is a phenolic heteropolymer with a large number of bonds and functional groups and is part of lignocellulosic biomass.

Lignocellulosic biomass consists mainly of three biopolymer units: cellulose, hemicellulose and lignin. Lignin can make up a significant proportion of 15-25% of the dried lignocellulosic biomass. It is a by-product of biorefineries, for example, and is usually used as a boiler fuel. The structure of lignin consists mainly of three alcohol units, namely cumaryl, coniferyl and sinapyl alcohols.

Lignin is used for the production of various types of high-quality products that are marketed in small quantities, for example, including carbon fibers and lignin-based adhesives. In recent decades, lignin has been used as a partial or complete replacement of phenol in PF wood adhesives. However, these compositions often still comprise formaldehyde.

According to the invention, however, it could be shown that formaldehyde can be further dispensed with if the lignin structure is specifically functionalized. Starting with lignin, it was shown in detail that a specific functionalization can lead to particularly advantageous properties for an adhesive. Here, it was considered that the lignin structure can be functionalized in particular via two paths, namely via the hydroxyl groups (i.e. primary) (1°) hydroxyl, secondary) (2°) hydroxyl or phenolic (Ph-OH) hydroxyl groups) and via the double bonds of the aromatic rings. It is thus particularly preferred according to the invention if the lignin is functionalized at at least one position selected from a side chain, an aryl ring, and/or a hydroxyl group. With regard to the hydroxyl groups, for example, only the groups of the side chains can be functionalized, since these are primary hydroxyl groups and thus more reactive, as indicated above.

This was exploited according to the invention in that the lignin structure is a lignin functionalized by reaction with dimethylformamide and acrylic acid. In particular, such functionalization can have significant advantages over the solutions from the prior art, especially the provision of lignin in an adhesive composition, as already indicated above.

It has been shown, for example, that an adhesive composition generally develops a very strong adhesive effect regardless of the type of join partners to be used. As a result, a very stable bonding can be achieved, which enables a wide range of applications.

This is further improved by the fact that the adhesive layer produced is very stable. Thus, a very strong mechanical stability could be achieved. Furthermore, an excellent stability against weathering and thus a pronounced long-term stability could be demonstrated.

In addition, the starting materials for producing the adhesive composition are far less problematic, particularly compared to the solutions from the prior art relating to phenol-formaldehyde resins. Lignin, acrylic acid and dimethylformamide are environmentally friendly and cause less and/or no health problems, especially compared to phenol and formaldehyde. The present invention demonstrates the complete replacement of phenol by lignin and formaldehyde by acrylic acid together with dimethylformamide as solvent or functionalization reagent. The toxicity of the adhesive can thus be significantly reduced. This significantly simplifies production and application.

Lignin as an essential component of lignocellulosic biomass is an extremely sustainable and renewable solution that can be processed in order to completely replace petroleum-derived fuels, chemicals, materials and polymers.

Particularly preferably, the adhesive composition can be free of formaldehyde. In particular in this embodiment, in which formaldehyde is completely dispensed with, the adhesive composition can be improved in terms of its ecological properties. This can significantly reduce the risk to living organisms and the environment, in particular compared to conventional phenol-formaldehyde resins. The possibility of dispensing with formaldehyde entirely can be achieved in particular by the special type of functionalization of the lignin structure by means of a reaction with dimethylformamide and acrylic acid. As a result, the properties, particularly with regard to an adhesive effect and resistance as described above, can also be achieved without providing formaldehyde. This is not possible with solutions from the prior art, which often still have to use formaldehyde as a component of the adhesive composition.

The same applies if the use of phenol is dispensed with and the adhesive composition is therefore completely free of phenol.

A further advantage of the adhesive composition described herein is the improved sustainability of the production process. This is because the unused or unreacted chemicals, such as acrylic acid (boiling point 141° C.) and dimethylformamide (boiling point 153° C.), can be recycled by the distillation and reused accordingly. Any sodium hydroxide used to create a basic medium can also be separated, for example from a washing solution for washing or cleaning the produced adhesive, and returned to the production of the adhesive. The improved sustainability is also demonstrated by the fact that no waste is produced when lignin is recycled. Rather, the adhesive composition can be used immediately after production without further significant processing steps, such as fractionation or depolymerization.

The described adhesive composition may further consist of the functionalized lignin, i.e. comprise about 100% by weight of functionalized lignin. However, it is also within the scope of the present invention if the adhesive composition still comprises used and non-functionalized lignin. For example, the adhesive composition may comprise functionalized lignin in an amount of ≥80 wt.-%, for example ≥90 wt.-%, preferably ≥95 wt.-%, such as ≥99 wt.-%. As indicated above, the remainder may comprise non-functionalized lignin or other traces resulting from the functionalization reaction, since it is not necessary to isolate the functionalized lignin. Here, the above-mentioned proportions refer in particular to the dry content of the adhesive composition and in particular not to a water content resulting from a washing process or another solvent.

It may further be preferred that the lignin structure is cross-linked. In this embodiment, an adhesive layer to be formed can develop a particularly strong adhesive effect and also be particularly durable. For example, the mechanical stability of the adhesive layer to be formed can be improved.

Crosslinking can take place in particular during functionalization, for example by creating crosslinking points via side chains or by creating an aryl network.

Lignin has two active sites, namely the aromatic ring and the functionalities that are present via the ring and the side chains. These side chains include various types of groups, including ester, carboxyl, carbonyl, hydroxyl, methoxy, etc. These functional groups can be activated as needed and significantly change the chemical, physical and biological properties of modified lignin and increase its value. These processes create a new macromolecule that can be more reactive and effective for further tuning of the modified lignin via the hydroxyl groups (primary, secondary or phenolic hydroxyl group) or the active ring site.

With regard to further advantages and technical features of the adhesive composition, reference is made to the description of the method, the use, the figures and the description of the figures.

Moreover, a method for producing an adhesive composition is described, characterized in that the method comprises the following steps:
a) providing lignin;
b) carrying out a reaction of the lignin with dimethylformamide in a basic medium;
c) carrying out a reaction of the reaction solution formed in process step b) with acrylic acid;
d) optionally at least partially drying the reaction product obtained; and
e) optionally washing the reaction product.

The method described herein thus describes the production or generation of an adhesive composition. This is designed in particular as described above and thus comprises a lignin structure, wherein the lignin structure is a lignin functionalized by reaction with dimethylformamide and acrylic acid.

In order to realize this, the method first comprises according to method step a) providing lignin. For example, lignin can be provided as a by-product of biorefineries or can also be derived from plants, since about 20 to 30% of the dry mass of lignified plants consist of lignin.

In principle, any lignin can be provided and used as a starting point for subsequent modification or functionalization. Preferably, however, an untreated lignin can be provided in process step a). In the sense of the invention, an untreated lignin can be understood to be a crude lignin which has been isolated directly from a plant, for example. Complex processing steps of the lignin are not required.

The lignin provided can then react with dimethylformamide in a basic medium according to process step b). Accordingly, it can be advantageous to use dimethylformamide as a solvent in order to reduce the substances used and also to reduce unreacted residual products. For example, sodium hydroxide can be added to adjust a basic medium. An exemplary pH value can be in a range of ≥7, preferably ≥8, for example in a range of ≥11 to ≤12. Furthermore, this reaction can take place at room temperature (20° C.). In principle, room temperature or slightly elevated temperatures are suitable up to slightly elevated temperatures, for example in a range from 20° C. to 30° C., and furthermore reaction times in a range from 30 minutes to two hours, for example one hour.

Furthermore, at the start of method step b), lignin can be introduced into dimethylformamide in such an amount that a solid to liquid ratio of ≥100 g/l to ≤200 g/l (g [lignin]/l [dimethylformamide]) is present.

Furthermore, according to method step c), the reaction solution obtained in method step b) is reacted with acrylic acid. Thus, in this step, after a suitable reaction phase of method step b), a suitable amount of acrylic acid can be added to the reaction of the lignin, which may already have been functionalized with dimethylformamide.

Method step c) can take place at a temperature which is elevated compared to method step b). Suitable temperatures include a range from ≥50° C. to ≤200° C., for example from ≥90° C. to ≤125° C., for example from ≥100° C. to ≤110° C. In addition, reaction times in a range from ≥12 hours to ≤48 hours, for example from ≥21 hours to ≤27 hours, for example of ≤24 hours are advantageous. A total time of method steps b) and c) can be in a range of ≤30 hours, for example ≤25 hours.

According to method step d), the reaction product obtained can subsequently be dried or, according to method step e), the reaction product can subsequently be washed. Washing can serve to remove the unreacted reactants, such as DMF, acrylic acid, impurities of lignin and/or base, and drying can remove the washing liquid, such as water. Active drying can be carried out for this purpose, for example while applying heat to the reaction product, in particular by use of a heating unit. Alternatively, passive drying can also take place, for example without active steps at ambient conditions, for example at room temperature (about 22° C.). Suitable drying times can then range from several hours to a few days, for example two days, for example from 23 to 25 hours, such as 24 hours.

For example, the reaction product dried to a moisture content of 80 wt.-%, in particular based on water, can then be used directly as an adhesive, wherein further processing steps can preferably be dispensed with apart from the aforementioned washing, which can take place prior to drying.

Accordingly, the method for producing an adhesive composition comprises a method for producing an adhesive.

Preferably, method steps b) and c) can be carried out at least partially simultaneously in a common reaction mixture by increasing the temperature in method step c) compared to method step b). This allows the functionalization of the lignin to proceed in the desired manner using both functionalization reagents, DMF and acrylic acid.

However, it is preferred that first mixing of lignin and dimethylformamide is carried out for a certain period of time and only then acrylic acid is added to the mixture according to method step c) in order to react with lignin or possibly the product already reacted with dimethylformamide. For example, step b) can be carried out in a period of 10 minutes to 120 minutes, such as from 45 minutes to 70 minutes, before acrylic acid is added. In this embodiment, for example, heating can only take place when the mixture is fully formed.

The advantage of first reacting dimethylformamide with lignin and then adding acrylic acid to the lignin-DMF reaction is associated with several advantages, such as maximum solubilization of lignin and under the basic medium. Furthermore, lignin or dimethylformamide can be activated for a spontaneous reaction with acrylic acid.

With regard to the ratio of the reaction educt used, it may also be advantageous for lignin and acrylic acid to be present relative to one another in a ratio of lignin:acrylic acid of greater than 0.5:1, preferably greater than 0.7:1, for example up to 2:1, for example up to 3:1, specified in percent by weight. These values refer to the quantities originally introduced into the reaction mixture. Surprisingly, it has been shown that a particularly high yield of the formed adhesive is possible in particular with this composition. As a result, recycling steps for reusing the educts can be further reduced and the applicability can be improved accordingly.

The development of lignin-based adhesive resins with a high yield, for example in a range of up to 90%, based on the dried lignin used, enables an efficient production and provides a particularly advantageous alternative solution to PF resins in today's bio-based adhesives. Furthermore, purification, fractionation or other additional steps are not required to synthesize a lignin-based adhesive, which further improves the application.

Thus, the described method provides a way to produce an adhesive composition or adhesive which is characterized by a simple and sustainable production and provides an adhesive with excellent adhesive properties for a variety of applications.

Accordingly, moreover, an adhesive composition produced according to a method as described above is described.

With regard to further advantages and technical features of the method, reference is made to the description, the adhesive composition, the use, the figures and the description of the figures.

Moreover, the use of lignin functionalized with acrylic acid and dimethylformamide as an adhesive, in particular for paper, plastics, glass, wood and metals, is described.

Although the adhesive described here basically offers very good properties for bonding all materials, however, it has been found that particularly good adhesive properties or adhesion properties are present especially when used for bonding paper, plastics, glass, wood and metals, at least as one join partner, preferably as both join partners. For example, bonding with at least one bonding partner made of a wide variety of paper types, such as kraft paper, glass, aluminum, stainless steel, polycarbonate, polyvinyl chloride and wood may be preferred.

With regard to further advantages and technical features of use, reference is made to the description of the adhesive composition, the method, the figures and the description of the figures.

In the following, the invention is explained by way of example with reference to the attached drawings, wherein the features shown below can represent an aspect of the invention both individually and in combination, and wherein the invention is not limited to the following drawing, the following description and the following exemplary embodiment.

### IN THE FIGURES

FIG. 1 is a diagram showing the yield of an adhesive according to the invention at different educt ratios;

FIG. 2 is a diagram showing an FT-IR analysis of lignin and a lignin-based adhesive according to the invention in a first spectral range;

FIG. 3 is the FT-IR analysis from FIG. 2 in a further spectral range;

FIG. 4 shows DSC curves of lignin and a lignin-based adhesive according to the present invention;

FIG. 5 shows a thermogravimetric analysis of lignin and a lignin-based adhesive according to the present invention;

FIG. 6 shows a ¹³C-NMR of lignin;

FIG. 7 shows a ¹³C-NMR of a lignin-based adhesive according to the present invention;

FIG. 8 shows a ¹³C-1H correlation HSQC NMR of lignin and a lignin-based adhesive together with a representative structure of various bonds in lignin and modified lignin;

FIG. 9 shows a storage modulus and tan delta data of an adhesive according to the invention;

FIG. 10 shows loss modulus data of an adhesive according to the invention and a comparative adhesive;

FIG. 11 shows mechanical data of an adhesive according to the invention; and

FIG. 12 shows a schematic representation of an arrangement for testing the adhesive properties of an adhesive composition according to the invention.

The figures show various measurements for characterizing and examining an adhesive, wherein the adhesive is a constituent of an adhesive composition, wherein the adhesive composition is a bio-based adhesive composition comprising a lignin structure, wherein the lignin structure is a lignin functionalized by reaction with dimethylformamide and acrylic acid.

As described in greater detail below, such an adhesive can in principle be prepared by a process comprising the following steps:
a) providing lignin;
b) carrying out a reaction of the lignin with dimethylformamide in a basic medium;
c) carrying out a reaction of the reaction solution obtained in process step b) with acrylic acid;
d) optionally at least partially drying the reaction product obtained; and
e) optionally washing the reaction product.

In the following, an example is described which characterizes the production of an adhesive composition or an adhesive in one embodiment.

### Materials Used

UPM BioPiva™ 100 lignin from UPM Biochemicals, Helsinki, Finland, was used and air-dried at room temperature for 24 hours before use. Sodium hydroxide was purchased from Sigma-Aldrich, Darmstadt, Germany. Dimethylformamide (99.8%), methanol (99.8%), ethanol (99.9%) and tetrahydrofuran (THF, 99.9%) were purchased from Th. Geyer GmbH. Dimethylsulfoxide-d6 was purchased from Carl Roth GmbH. Acrylic acid (AA) stabilized with 200 ppm 4-methoxyphenol was purchased from Alfa Aesar, Germany. Chromium (III)-acetylacetonate was purchased from Sigma-Aldrich, USA. Anhydrous dimethylformamide (99.8%) and anhydrous pyridine (99.8%) were purchased from Sigma Aldrich, Germany. All chemicals were used as supplied, and no purification step was required.

### Synthesis of Lignin-Based Adhesive

Lignin (1.0 g, based on dried lignin) was added to a glass pressure tube (35 ml, or 120 ml for 3.0 g sample FengTecEx GmbH, Darmstadt) and mixed with 10 or 30 ml DMF and 100 or 300 mg NaOH, respectively. The reaction mixture was stirred with a stir stick (500 rpm) for 1 h at room temperature (RT). Acrylic acid (1.0 g or 3.0 g) was then added to the same mixture and stirred further for 24 h at room temperature (total reaction time 25 h). The obtained reaction mixture was processed for lignin functionalization for 45 h in a preheated oven at 105±2° C. Thereafter, the stirred mixture was cooled at room temperature (cooling time ˜20 min). DI water (50 ml or 150 ml) was added to the stirred mixture and centrifuged at 4000 rpm for 10 min (Universal 320, Hettich, Germany). The obtained semi-solid lignin-based adhesive was dried at room temperature for 24 hours, and the yield was calculated using charged lignin as the denominator after the adhesive was dried at 105±2° C. for 4 hours.

In addition, adhesive (lignin:acrylic acid 1.0:1.0 wt./wt.) was synthesized on a large scale (3.01 kg) for further applications as wood chipboard, wood fiberboard and wood-related materials.

The adhesive was also produced in different educt ratios. Lignin:acrylic acid, 1.0:0.5 and 0.5:1.0, wt./wt. was produced according to the same process as the adhesive lignin:acrylic acid, 1.0:1.0 wt./wt., except for the different amounts of acrylic acid and lignin. Acrylic acid (0.5 g) and lignin (0.5 g) were used for the synthesis of adhesive (lignin:AA, 1.0:0.5) and adhesive (lignin:AA, 0.5:1.0), respectively.

The following methods were used to characterize or analyse the adhesive produced.

### Fourier Transform Infrared (FT-IR)

The functional groups in both the lignin and the adhesive were characterized by use of the ATR technique (ALPHA Bruker) using OPUS 7.5 software. The spectra were recorded with a resolution of 4 cm⁻¹ and 32 phase resolutions. The sample scan time was 24 scans, and the data were stored from 4000-400 cm⁻¹. Prior to analysis, samples were dried at 105±2° C. for 4 hours and stored in a glass vial with a PTFE lid.

### Thermogravimetric Analysis (TGA)

The thermal decomposition of the samples was measured by use of the TG 209 F1, NETZSCH, Germany. Approximately 10 mg of sample with a heating rate of 20 K/min to 800° C. in an N2 atmosphere was used to measure thermal decomposition.

### Differential Scanning Calorimetry (DSC)

The DSC analysis of the samples was measured by use of the DSC 200 F3, NETZSCH, Germany. Approximately 10 mg of the sample were heated at a heating rate of 10 K/min up to 300° C. in an N2 atmosphere for the DSC analysis.

¹³C and ¹³C-1H Correlation 2D-HSQC-NMR

The heteronuclear ¹³C and ¹³C-1H single quantum correlation (HSQC) NMR spectra of lignin and lignin-based adhesive samples were measured by use of 500 MHz and 600 MHz instruments of Brucker, respectively. 100 mg (dried) sample and chromium (III)-acetylacetonate (˜2.0 mg) were supplied into a glass vial. DMSO-d6 (0.6 ml) was added to the same vial and sonicated for 10 minutes to facilitate solubilization. The fully dissolved sample was transferred to an NMR tube and processed for NMR spectra. The ¹³C NMR spectra were recorded from −31.21 ppm to 230.30 ppm with an recording time of 996.15 ms (AQ) and a receiver gain of 203. The ¹³C NMR tube was processed for ¹³C-1H correlation 2D HSQC NMR spectra by use of 600 MHz instruments, and analysis was performed at 600.25 MHz and 150.93 MHz for 1H and ¹³C nuclei, respectively. The current pulse program hsqcedetgpsisp2.3 was used. The ¹H and ¹³C spectra were recorded from 0 to 15.2 ppm and 0 to 220.0 ppm with AQ of 112.64 and 7.71 ms, respectively. The semiquantitative relative frequency of bonds, including β-O-4, β-β and β-5, was measured by use of Bruker TopSpin 4.0.7 software.

¹⁵N-¹H Correlation 2D-HMBC NMR

A similar solution as for the ¹³C NMR spectra was prepared for the ¹⁵N-1H correlation 2D heteronuclear multiple bond correlation (HMBC). The HMBC analysis was carried out at 500.25 MHz and 50.71 MHz for 1H and 15N nuclei, respectively. The hmbcgpndqf current pulse program was applied with an AQ of 204.80 ms and 67.32 ms for 1H and 15N nuclei, respectively. The applied receiver gain was 203.

### DMTA Measurement

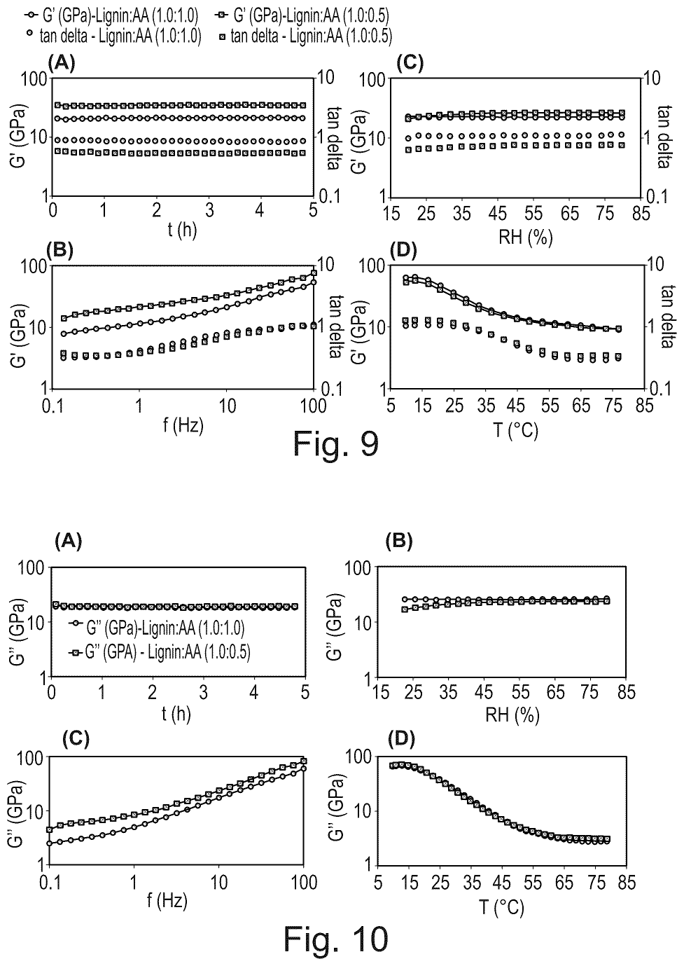

The DMTA measurement was carried out by use of a DMA GABO EPLEXOR system (NETZSCH GABO Instruments GmbH) with a force sensor of 50.0 N. The applied static and dynamic force loads were 10.0 N (0.1% limit) and 5.0 N (0.05% limit) respectively. The applied contact force was 0.5 N. The soaking time for all samples was 300 s. The temperature sweep test (10-80° C.) was carried out at 30% relative humidity (RH) with a frequency of 10.0 Hz and a temperature rise rate of 2 K/min. The frequency sweep test (0.1-100.0 Hz) was carried out at 25° C. and 30% relative humidity with a frequency increase of 8.0 steps per decimal place. The RH (10%-80%) sweep test was carried out at 25° C. with a frequency of 10.0 Hz. The time sweep test (0-5 h) was carried out at 25° C. and 30% RH with a frequency of 10.0 Hz. Prior to the analysis, the adhesive samples were glued between two glass slides and dried at 105±2° C. for 2 h. The glued samples with different dimensions of 10.0 mm×0.005 mm for adhesive (lignin:AA, 1.0:1.0 wt./wt.), and 9.0 mm×0.001 mm for adhesive (lignin:AA, 1.0:0.5 wt./wt.) were used for DMTA. In addition, the dimensional correction factor was applied for the different samples. The DMTA test of the adhesive (lignin:AA, 1.0:1.0 wt./wt.) was carried out repeatedly, and the average of the repetitions (temperature, time, frequency and moisture sweep tests) is shown in FIGS. 9 and 10.

### Contact Angle and Surface Free Energy

The contact angle (CA) and the surface free energy (SFE, polar and dispersive energy) of samples with and without adhesive were determined by use of OWRK, an SFE model. The water droplet on the samples were recorded with a video camera. The contact angle was measured by use of the image analysis software. Water and diiodomethane were used as liquids with different polarities to measure the SFE. At least 3 to 6 surface points/sample with 30 to 60 data sets were taken to determine the CA and SFE, of which the average is shown. For the determination of CA and SFE, the plane surfaces of glass (G), polyvinyl chloride (PVC), stainless steel (SS), polycarbonate (PC) and aluminum (Al) and their bonded samples were used. Prior to analysis, very fine adhesive layers (adhesive thickness 0.031±0.007 mm) were applied to the materials and dried at 105±2° C. for 2 h.

### Physical-Mechanical Test

Vertical or horizontal physical-mechanical tests of the adhesive were performed on various materials, including G, PVC, PC and pine wood (about 20 years old). Approximately 10 mg (dried) were applied to laminate the materials (except wood ˜100 mg, dried base, due to porosity) between two layers, and the laminated samples were dried at 105±2° C. for 2 h.

### Weathering Test

The PC and PVC bonded samples were tied with a cable tie over a wire net and tilted by 45 degrees. The height of the net above the ground was approximately 1.2 meters. The samples were processed for the weathering test from 13.09.2021 to 15.11.2021 at the test field of the Georg-August-University Göttingen.

### Testing the Internal Bond Strength

The internal bond strength (IBS) of the adhesives on G, SS, PC and Al was measured in accordance with DIN EN 1607 (2013). Prior to the IBS measurement, the adhesive samples were dried for 2 h at 105±2° C. The different G, SS, PC and Al-IBS samples (50 mm×50 mm, except Al) were bonded between two Al yokes (for Al-IBS, the sample was used directly without fixation with yoke). The fixed samples were tested by use of a universal testing device (Zwick Roell, Ulm, Germany).

### Evaluation of the Tests

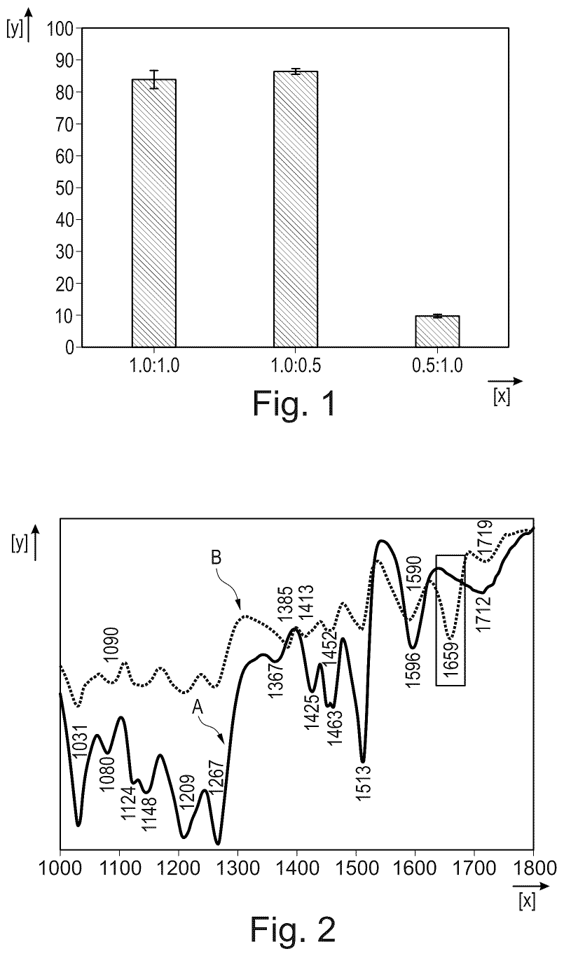

The lignin-based universal adhesive was synthesized by use of lignin and acrylic acid in dimethylformamide as the basic medium, wherein the educt ratios were modified as described above. The results are shown in FIG. 1, wherein the X-axis shows the ratio of lignin to acrylic acid in weight percent and the Y-axis shows the yield.

Three different ratios of lignin and acrylic acid (1.0:1.0, 1.0:0.5 and 0.5:1.0 wt./wt.) with constant solid/liquid ratios (10 wt.-%, lignin weight/volume DMF, except as explicitly noted later (20 wt.-%)) were used and almost similar yields of 84% and 86% were obtained by use of lignin and acrylic acid at ratios of 1.0:1.0 and 1.0:0.5, respectively. In contrast, the yield with a ratio of lignin:acrylic acid (0.5:1.0) is comparatively low, which is due to the high solubility of lignin or modified lignin in DMF, which was washed out after centrifugation.

Further, the functionalization of the lignin could be demonstrated as follows.

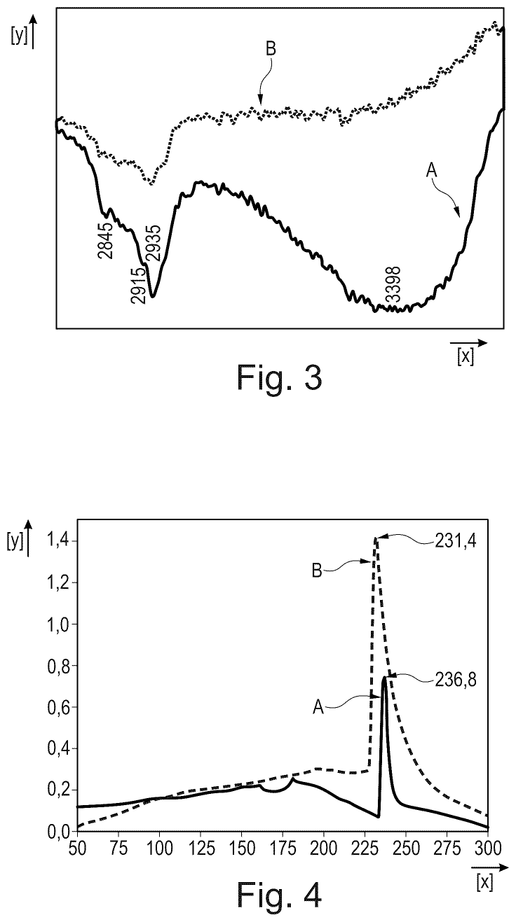

The presence of nitrogen in a lignin-based adhesive confirms lignin functionalization involving dimethylformamide, which is also confirmed by the occurrence of new peaks at 1654 cm⁻¹ for amide and 1385 cm⁻¹ for —C(CH₃)₂ groups in a corresponding IR spectrum. This can be demonstrated by the FT-IR spectrum of lignin and the adhesive produced. The corresponding spectra are shown in FIGS. 2 and 3, wherein the X-axis shows the wavenumber in [cm⁻¹] and the Y-axis shows the corresponding absorbance. Furthermore, curve A corresponds to the starting product lignin and curve B corresponds to the functionalized lignin, i.e. the adhesive.

The occurrence of new peaks in the lignin-based adhesive represents the change in the lignin structure due to functionalization with dimethylformamide or with acrylic acid, which can also be shown as a characterization of the lower glass transition temperature of the adhesive compared to lignin. This can be seen in the corresponding DSC spectra as shown in FIG. 4. In FIG. 4, curve A again corresponds to the starting product lignin and curve B corresponds to the functionalized lignin, i.e. the adhesive. Furthermore, the X-axis shows the temperature in [° C.] and the Y-axis shows the heat flow in [W/g].

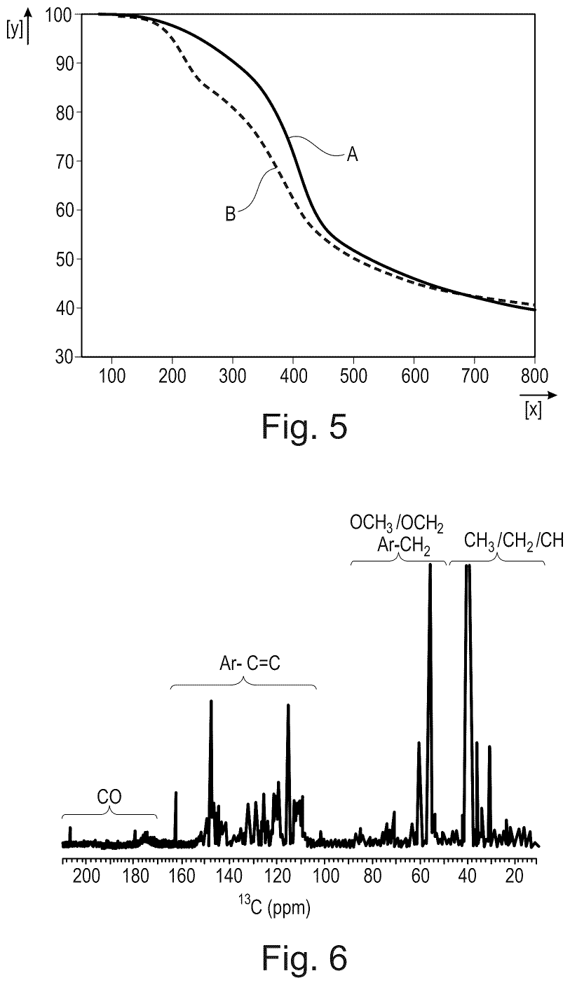

The lower glass transition temperature of the lignin-based adhesive also indicates the cross-linking of the lignin structure. The functionalization or crosslinking of lignin to a lignin-based adhesive is confirmed by thermogravimetric analysis, as shown in FIG. 5, which shows spectra from corresponding TGA measurements. In this regard, it should be noted that the cross-linked functionalities of the adhesive are degraded at lower temperatures compared to lignin, resulting in the lower glass transition temperature. In FIG. 5, curve A again corresponds to the starting product lignin and curve B corresponds to the functionalized lignin, i.e. the adhesive. Furthermore, the X-axis shows the temperature in [° C.] and the Y-axis shows the weight loss in [%].

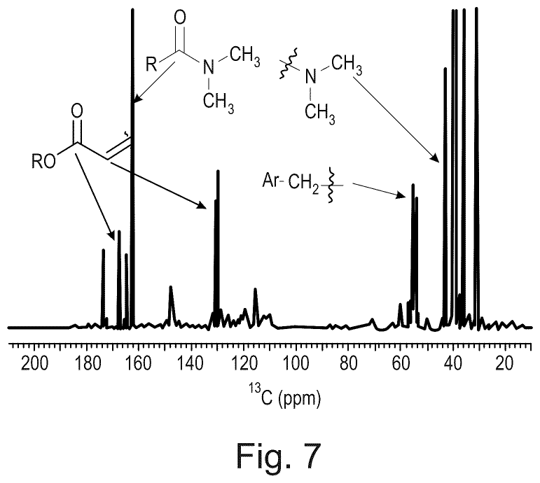

To substantiate the FT-IR, DSC and TGA characterization studies according to FIGS. 2 to 5 and thus to confirm the functionalization of the lignin, ¹³C-NMR spectra of both lignin and lignin-based adhesive were recorded. These are shown in FIGS. 6 and 7, wherein FIG. 6 shows a ¹³C-NMR of the starting product lignin and FIG. 7 shows a ¹³C-NMR of the functionalized lignin, i.e. the adhesive.

A considerable number of new ¹³C peaks are observed in the lignin-based adhesive. The chemical shift for the —N(CH₃)₂ peak is observed at 43.21 ppm, and this peak in the lignin-based adhesive can be confirmed by the solvent used to solubilize and functionalise lignin. A similar situation also applies to the peaks at 55.57 and 162.30 ppm for the Ar—CH₂ and R—(CO)—N(CH₃)₂ groups, and these groups can also be explained for lignin functionalization by the solvent.

Furthermore, some additional peaks at 130.40 and 167.40 ppm are characterized for the RO(CO)CH—CH and RO(CO)CH—CH carbons, and it can be explained that these carbons are generated in the lignin-based adhesive by the acrylic acid that functionalized the lignin.

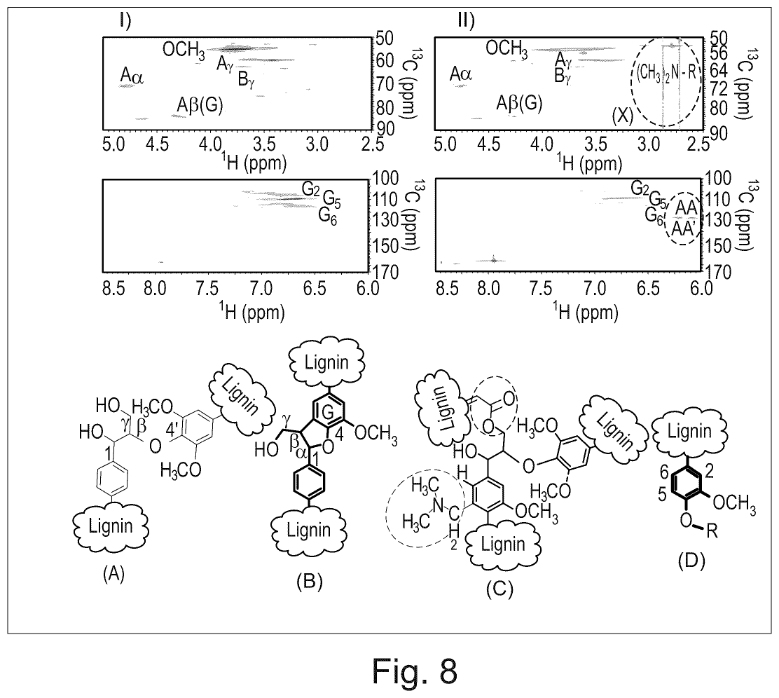

Furthermore, to confirm the functionalization of lignin by DMF and acrylic acid in the lignin-based adhesive, the ¹³C-1H correlation 2D HSQC NMR spectra were recorded, wherein FIG. 8 shows corresponding 2D HSQC NMR images. The left figures (I)) refer to lignin and the right figures (II)) to the formed adhesive. New signals in aliphatic and aromatic regions are assigned to the introduced R—N(CH₃)₂ and RO(CO)CH—CH groups when comparing the spectra of lignin and adhesive.

Characteristic regions of lignin (left) and functionalized lignin are also shown in the lower part of FIG. 8. Here, (A) shows β-aryl ether (β-O-4′), (B) shows phenylcoumarin (β-5, α0-4), (C) shows functionalized lignin and (D) shows guaiacyl.

### Mechanical Properties of the Adhesive

The mechanical properties, such as storage modulus G′ in [GPa], loss modulus G″ in [GPa] and tan delta, of lignin-based adhesives with different lignin/acrylic acid ratios were investigated by use of dynamic mechanical thermal analysis (DMTA) to study the synergistic crosslinking of lignin with dimethylformamide and acrylic acid.

The DMTA analysis of the samples was analyzed over time (t), temperature (T), frequency (f) and relative humidity (RH), as shown in FIGS. 9 and 10.

More specifically, FIG. 9 shows DMTA data for the storage modulus (G′) of the adhesive (lignin:acrylic acid (AA), 1.0:1.0, and 1.0:0.5 wt./wt.). (A) time sweep at 25° C. and 30% RH with a frequency of 10 Hz, (B) frequency sweep at 25° C. and 30% RH, (C) RH sweep at 25° C., with a frequency of 10 Hz, and (D) temperature sweep at 30% RH at a frequency of 10 Hz and a temperature rise rate of 2 K/min.

Furthermore, FIG. 10 shows DMTA data of adhesive (lignin:acrylic acid (AA), 1.0:1.0 and 1.0:0.5 wt./wt.), wherein (A) shows the time sweep at 25° C. and 30% relative humidity with a frequency of 10 Hz, (B) the frequency sweep at 25° C. and 30% relative humidity, (C) the RH sweep at 25° C. with a frequency of 10 Hz and (D) the temperature sweep at 30% relative humidity with a frequency of 10 Hz and a temperature rise rate of 2 K/min.

The storage modulus and the tan delta values are stable for more than 4 hours at 25° C., 30% relative humidity and a frequency of 10 Hz, which causes the local relaxation and dynamic reaction states of lignin-based adhesives. However, the DMTA data of lignin-based adhesives (lignin:AA ratio, 1.0:0.5 wt./wt.) show the high storage modulus (35.4 GPa) compared to lignin:AA ratio (1.0:1.0 wt./wt., 21.2 GPa), which can plausibly be explained by the minimal functionalization (i.e. side chains) of the lignin-based adhesive (lignin:AA ratio (1.0:0.5 wt./wt.)) (FIG. 9). The good mechanical stability of the lignin-based adhesive under the applied static and dynamic loads indicates the stiffness and robustness of the material without any fatigue over a long period of time.

The storage modulus of both lignin-based adhesives increases significantly over the tested frequency (0.1 to 100 Hz) at 25° C. and 30% relative humidity. The considerable increase in storage and loss modulus indicates the cross-linking and densification of the lignin-based adhesive at the tested frequency, which further strengthen the internal and external bonds of the adhesive.

Lignin bonds with both the hydrophobic (aryl moiety) and hydrophilic (alkyl alcohol side chains) groups, which results in the formation of two-sided chain cross-links or aryl networks. FIG. 9C shows the influence of the relative humidity on the mechanical properties of lignin-based adhesives. The storage modulus of the adhesive (lignin:AA ratio, 1.0:0.5 wt./wt.) increased slightly from 21.1 GPa to 26.7 GPa when the relative humidity increased from 19.8% to 79.6%.

The physiological properties, such as the storage modulus of adhesives, generally change with the applied temperature; at low temperatures the materials usually remain in a glassy/crystalline state and change to a rubbery/melted state at higher temperatures. Storage modulus and tan delta of the two lignin-based adhesive samples are high and stable at low temperatures (˜16.0° C.), but decrease significantly up to 48.8° C. (˜75%) and then decrease slightly up to the tested temperature (˜24.6%, 78.7° C.) (FIG. 9D). This can be plausibly explained by the formation of the polymer gel at a higher temperature, which tends to ensure the maximum mobility of the polymer chains or reduce the strength of intermolecular interactions.

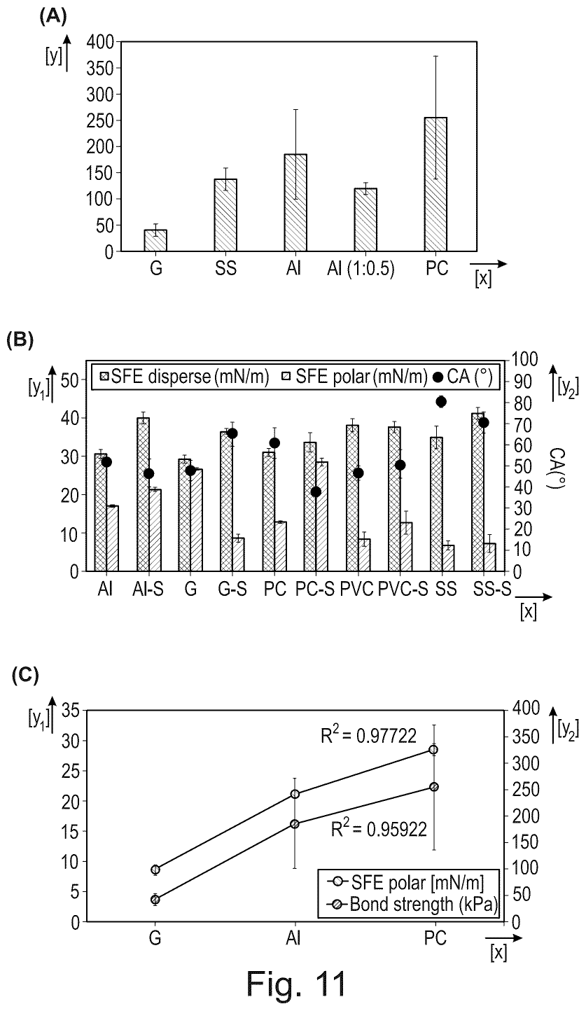

FIG. 11 further shows under (A) the internal bond strength (IBS) in [kPa] of the adhesive, shown on the Y-axis, with a reference across different materials on the X-axis, namely glass (G), stainless steel (SS), aluminum (Al), and polycarbonate (PC). Furthermore, FIG. 11 shows under (B) the cumulative surface energy (SFE) polar (p) and dispersive (d), each in [mN/m] on the Y1-axis, and the contact angle CA, [°] on the Y2-axis, wherein the S describes adhesions of the adhesive at the materials. FIG. 11 also shows under (C) a correlation between the cumulative surface energy (SFE) in [mN/m] polar on the Y1 axis and internal bond strength in [kPa] on the Y2 axis. Unless otherwise stated, the measurements were carried out with a lignin/acrylic acid ratio of 1.0:1.0 (wt./wt.).

The adhesion property of the lignin-based adhesive depends on the internal bonding chains between the adherents and the adhesive. PC has bonded strongly to the adhesive compared to the other adhesives tested. Adhesive synthesized from both lignin:AA ratio (1.0:1.0 and 1.0:0.5 wt./wt.), which was characterized for adhesion properties on Al, and lignin:AA ratio (1.0:1.0 wt./wt.) showed the higher internal bond strength (˜35%) than the lignin:AA ratio (1.0:0.5 wt./wt.) derived adhesive.

The disperse surface energy (hydrophily) of the adhesives (G-S, Al-S, SS-S and PC-S) increases with the exception of PVC-S, while the polar surface energy (hydrophobicity) also increases throughout (except for G-S). The significant difference in the polar surface energy of PC (with and without adhesive) is measured (FIG. 10B), which can confirm the higher IBS of PC-S.

However, the polar interaction of acids and bases played a significant role in adhesion according to the acid-base theory. The hydrophily and hydrophobicity of lignin-based adhesives to the different adhesive types was determined by measuring the contact angle (CA) (FIG. 11B). The contact angle of G-S and PVC-S samples increases compared to the control samples, while a negative trend is measured for Al-S, SS-S and PC-S. This can plausibly be attributed to the orientation of the chemical components, e.g. functionalized phenolic moieties and side chains of the lignin-based adhesive.

In addition, the G-S, Al-S and PC-S samples showed a strong correlation between the SFE pole and the IBS (FIG. 11C). An excellent correlation fits for the polar SFE and the IBS of adherences to G, Al and PC with lignin-based adhesive, plotted with R2 of 0.98 and 0.96, respectively. This correlation indicates strong interactions between the G, Al and PC bonds and the lignin-based adhesive.

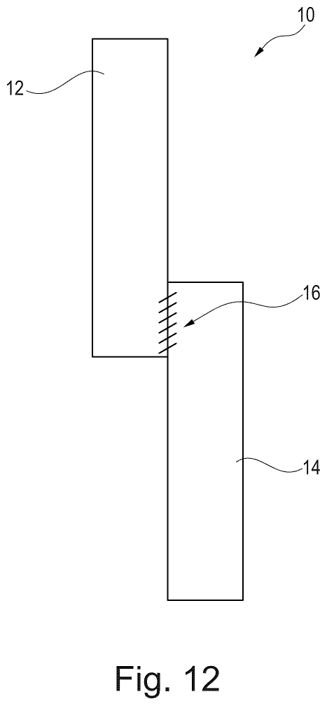

Physical-mechanical properties are important for characterization, bond strength, long-term durability, environmental compatibility and stability in various media for a variety of potential applications of adhesives. To demonstrate the interfacial adhesion and weathering test of lignin-based adhesives on G, PC, PVC, paper and wood, a rectangular surface was bonded with adhesive in an arrangement 10 and subjected to a vertical and horizontal physical-mechanical weight test, see FIG. 12. The surface resulted in a contact area or adhesive area 16 between two substrates 12, 14. The samples were then dried at 105±2° C. for 2 hours.

In summary, the following tests were carried out.

A vertical and horizontal physical-mechanical test was carried out by use of a weight of 1,500 g of the adhesive on PVC with bonding areas of 2.5 cm² or 5.0 cm² and PC with a bonding area of 5.0 cm² at different pH values and days (d).

Thus, the same bonded samples were immersed in DI water for 30 minutes at room temperature and the vertical mechanical load capacity was measured. The samples were able to hold 1500 g of metal weight without failure.

Furthermore, the samples previously treated with DI water were immersed in acidic water (pH 3.08, by use of 72% H₂SO₄) for 30 minutes at room temperature and the mechanical load capacity was tested again. The samples were successfully able to hold 1500 g of metal weight without failure.

The acidified samples were now immersed in a basic solution (pH 10.22, NaOH) for 30 minutes at room temperature and the mechanical load capacity was tested by placing a 1500 g metal weight on the same day and after 30 days (storage at room temperature). The vertical physical-mechanical weight test of the PC and PVC bonded samples confirms that the lignin-based adhesive is very stable under neutral, acidic and basic media for 30 days.

The samples immersed in basic solution were now processed for the weathering test over 64 days (from Sep. 13, 2021 to Nov. 15, 2021, Göttingen, Germany), and the samples showed a similar metal weight holding performance (1500 g) without failure.

The lignin-based adhesive thus showed excellent physical-mechanical properties after immersion of the adhesive samples in neutral, acidic (pH 3.08) and basic (pH 10.22) media. The lignin-based adhesive also exhibited a very high bond strength and an excellent stability during the weathering test (>64 days) and was basically able to hold more than 2,000 g of metal weight without failure, even after 94 days. A strong correlation was found between the surface energy (SFE) and the polar and internal bond strength with R2 values of 0.98 and 0.96 for different substrates.

A solubility study (0.1% wt./vol.) of the lignin-based adhesive was conducted in DI water as well as organic solvents, including methanol, ethanol, tetrahydrofuran (THF), dimethylformamide (DMF), and the qualitative data showed that this adhesive is insoluble in DI water, ethanol, moderately soluble in methanol and THF, and slightly more soluble in DMF. These data also show the stability of the adhesive in a normal environment.

Effective bonding was also demonstrated when bonding paper. In detail, it was shown in a tensile test that the bonded joint withstands and the paper tears. This could even be confirmed when using Kraft paper, which has an extraordinarily high tensile strength. Accordingly, an extraordinarily high adhesive performance was also demonstrated with paper.

In summary, Thus, a green, sustainable and bio-based universal adhesive could be produced by use of lignin, dimethylformamide (DMF) and acrylic acid (AA) as a basic medium. The internal bond strength (IBS) of the lignin-based adhesive was measured for different types of adhesives (G, Al, SS and PC), and the promising IBS was validated for the PC-bonded sample. The universal bio-based adhesive is environmentally compatible (>64 d) and chemically stable to acidic (pH 3.08), neutral and basic (pH 10.22) media. Excellent dynamic and physical-mechanical properties were measured for lignin-based adhesives. In this way, a synergistic, simple synthesis method for a universal lignin-based adhesive was developed to replace the commercially widely used formaldehyde-based resins and to provide the possibility of a potential solution to environmental and health problems.

1. A bio-based adhesive composition comprising a lignin structure, wherein the lignin structure is a lignin functionalized by reaction with dimethylformamide and acrylic acid.

2. The bio-based adhesive composition according to claim 1, wherein the lignin is functionalized at at least one position selected from a side chain, an aryl ring, and a hydroxyl group.

3. The bio-based adhesive composition according to claim 1, wherein the adhesive composition is free of formaldehyde.

4. The bio-based adhesive composition according to claim 1, wherein the adhesive composition is free of phenol.

5. The bio-based adhesive composition according to claim 1, wherein the lignin structure is crosslinked.

6. A method for producing an adhesive composition, wherein the method comprises the following steps:
a) providing lignin;
b) carrying out a reaction of the lignin with dimethylformamide in a basic medium;
c) carrying out a reaction of the reaction solution obtained in method step b) with acrylic acid;
d) optionally at least partially drying the reaction product obtained; and
e) optionally washing the reaction product.

7. The method according to claim 6, wherein method steps b) and c) are carried out at least partially simultaneously in a common reaction mixture.

8. The method according to claim 6, wherein dimethylformamide is used as solvent.

9. The method according to claim 6, wherein lignin and acrylic acid are present relative to one another in a ratio of lignin:acrylic acid of greater than 0.5:1, preferably of greater than 0.7:1, based on percent by weight.

10. The method according to claim 6, wherein an untreated lignin is provided in method step a).

11. An adhesive composition produced by the method according to claim 6.

12. A method of using lignin functionalized with acrylic acid and dimethylformamide as an adhesive, in particular for paper, plastics, glass, wood and metals.
